(19) United States
(12) Patent Application Publication
(10) Pub. No.: US 2020/0142339 A1
(43) Pub. Date: May 7, 2020

(54) IMAGE FORMING APPARATUS, AND METHOD AND PROGRAM FOR CONTROLLING IMAGE FORMING APPARATUS

(71) Applicant: KONICA MINOLTA, INC., Tokyo (JP)

(72) Inventor: Daiki YAMANAKA, Sagamihara-shi (JP)

(73) Assignee: KONICA MINOLTA, INC., Tokyo (JP)

(21) Appl. No.: 16/601,703

(22) Filed: Oct. 15, 2019

(30) Foreign Application Priority Data
Nov. 6, 2018 (JP) 2018-208784

(51) Int. Cl. G03G 15/00

(52) U.S. Cl. CPC G03G 15/5058

(57) ABSTRACT

An image forming apparatus that has a plurality of image formers arranged from an upstream side toward a downstream side in a moving direction of a transfer medium, each of the image formers forming a toner image on the transfer medium, includes a density detector that detects densities of toner images formed by the plurality of image formers, and a hardware processor that performs image stabilization control on each of the image formers, the image stabilization control being performed to form a plurality of patch images by changing levels of a parameter for image formation, the image stabilization control being performed to conduct correction on the parameter in accordance with respective densities of the patch images detected by the density detector.

The entire disclosure of Japanese patent Application No. 2018-208784, filed on Nov. 6, 2018, is incorporated herein by reference in its entirety.

### BACKGROUND

### Technological Field

The present invention relates to an image forming apparatus, and a method and a program for controlling the image forming apparatus.

### Description of the Related Art

In an image forming apparatus using an electrophotographic process, a photosensitive drum is electrically charged by a charging device, and laser light is emitted in accordance with image data, to form an electrostatic latent image on the photosensitive drum. As a developing device is supplied from a developing device to the photosensitive drum, the electrostatic latent image is visualized, and an image (a toner image) is formed on the photosensitive drum. The image formed on the photosensitive drum is transferred to a paper sheet via an intermediate transfer belt. The transferred image is then fixed, so that the image is formed on the paper sheet. This kind of image forming apparatus has a known configuration that includes a plurality of image formers arranged from the upstream side toward the downstream side in the running direction (moving direction) of the intermediate transfer belt that is a transfer medium.

In the image forming apparatus, image stabilization control is performed at an appropriate timing. In the image stabilization control, a plurality of patch images is formed on the intermediate transfer belt by varying the levels of parameters for image formation, and the density (the toner adhesion amount) of each patch image is detected. Parameter correction is then performed in accordance with the densities of the patch images (hereinafter referred to as “image density”). Through this correction, the image density can be optimized, and the image density can be stabilized. The parameters for image formation are development potential, charge potential, and the like. For example, JP 2006-220848 A and JP 2009-300901 A each disclose an image forming apparatus capable of stabilizing image quality.

When the patch images formed in an upstream-side image former pass through a downstream-side image former, a phenomenon (reverse transfer) which toner is transferred onto the photosensitive drum occurs sometimes. Therefore, in an upstream-side image former, the parameters are corrected, with the influence of reverse transfer being taken into account. On the other hand, if the parameters in a downstream-side image former are corrected, the amount of reverse transfer is also affected. Therefore, if the parameters in a downstream-side image former are corrected after the parameters in an upstream-side image former are corrected, the influence of reverse transfer accompanying the correction of the parameters in the downstream-side image former is not taken into account in correcting the parameters in the upstream-side image former. As a result, appropriate image formation characteristics cannot be obtained from the upstream-side image former, and correction accuracy is degraded.

### SUMMARY

The present invention has been made in view of the above circumstances, and aims to provide an image forming apparatus capable of obtaining appropriate image formation characteristics from image formers ranging from an image former on the upstream side to an image former on the downstream side, and a method and a program for controlling the image forming apparatus.

To achieve the abovementioned object, according to an aspect of the present invention, there is provided an image forming apparatus that has a plurality of image formers arranged from an upstream side toward a downstream side in a moving direction of a transfer medium, each of the image formers forming a toner image on the transfer medium, and the image forming apparatus reflecting one aspect of the present invention comprises a density detector that detects densities of toner images formed by the plurality of image formers, and a hardware processor that performs image stabilization control on each of the image formers, the image stabilization control being performed to form a plurality of patch images by changing levels of a parameter for image formation, the image stabilization control being performed to conduct correction on the parameter in accordance with respective densities of the patch images detected by the density detector, wherein the hardware processor performs the image stabilization control on the image formers from a downstream-side image former to an upstream-side image former, and the patch images formed in the upstream-side image former are made to pass through the downstream-side image former after correction of the parameter is performed in the downstream-side image former.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view of an image forming apparatus according to an embodiment;

FIG. 2 is a diagram for explaining reverse transfer;

FIG. 3 is an explanatory chart showing an outline of image stabilization control;

FIG. 4 is a flowchart showing the flow in a process to be performed by the image forming apparatus;

FIGS. 5A and 5B are explanatory charts showing the development potential and the like at different levels;

FIG. 6 is an explanatory chart showing the concept of correction control with priority on accuracy;

FIG. 7 is an explanatory chart showing the concept of correction control with priority on accuracy;

FIG. 8 is an explanatory chart showing the transition of the development potential and the like when three patch images are formed;

FIG. 9 is an explanatory chart showing the relationship between the development potential and the like and the image densities of the patch images;

FIG. 10 is an explanatory chart showing the transition of the development potential and the like when three patch images are formed;

FIG. 11 is an explanatory chart showing a situation in which patch image re-creation is performed starting from a black image former in a case where patch image creation is suspended in a cyan image former; and

FIG. 12 is an explanatory chart showing an outline of normal correction control.

### DETAILED DESCRIPTION OF EMBODIMENTS

Hereinafter, one or more embodiments of the present invention will be described with reference to the drawings. However, the scope of the invention is not limited to the disclosed embodiments.

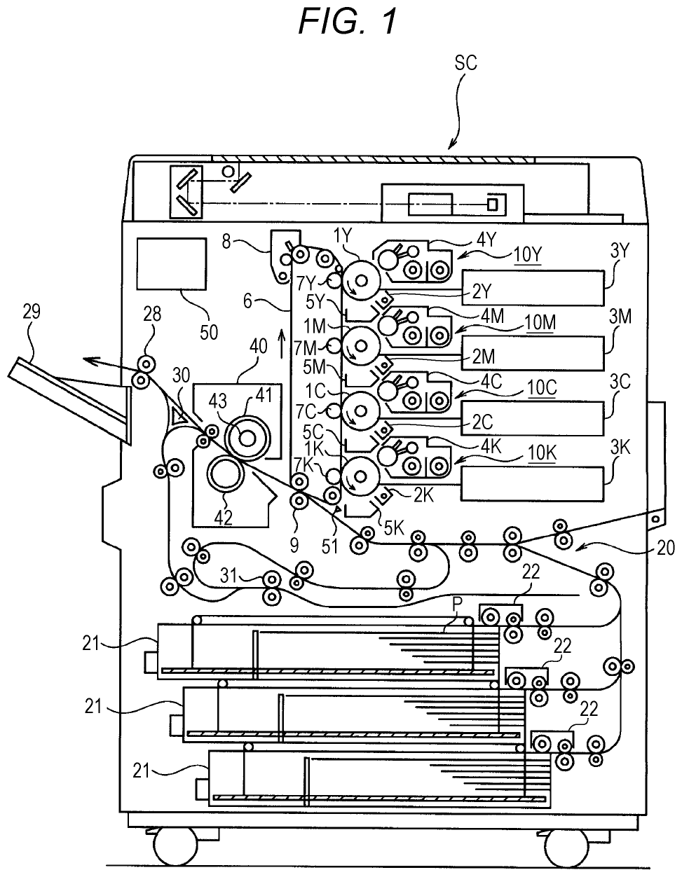

FIG. 1 is a schematic view of an image forming apparatus according to an embodiment. This image forming apparatus is an image forming apparatus using an electrophotographic process. Specifically, the image forming apparatus is a so-called tandem color image forming apparatus including a plurality of photosensitive drums that are arranged in the moving direction (the running direction) of an intermediate transfer belt from the upstream side toward the downstream side while facing the single intermediate transfer belt. With this arrangement, the image forming apparatus forms full-color images.

The image forming apparatus includes a document reading device SC, a plurality of image formers 10Y; 10M, 10C, and 10K, a fixing device 40, and a controller 50 as the principal components, which are accommodated in one housing.

The document reading device SC scans and exposes an image of a document with an optical system of a scanning exposure device, reads the reflected light with a line image sensor, and thus obtains an image signal. The image signal is subjected to processing such as A/D conversion, shading correction, and compression, and is then input as image data to the controller 50. The image data to be input to the controller 50 is not necessarily image data read by the document reading device SC, but may be data received from a personal computer connected to the image forming apparatus or another image forming apparatus, or may be data read from a portable recording medium such as a USB memory.

In this embodiment, the plurality of image formers 10Y, 10M, 10C, and 10K is an image former 10Y that forms yellow (Y) images, an image former 10M that forms magenta (M) images, an image former 10C that forms cyan (C) images, and an image former 10K that forms black (K) images. Facing an intermediate transfer belt 6, the four image formers 10Y, 10M, 10C, and 10K are arranged from the upstream side toward the downstream side in the moving direction (the traveling direction) of the intermediate transfer belt 6. Of the four image formers 10Y, 10M, 10C, and 10K, the yellow image former 10Y is located on the most upstream side, the magenta image former 10M and the cyan image former 10C are arranged in this order in the downstream direction, and the black image former 10K is located on the most downstream side.

The image former 10Y includes a photosensitive drum 1Y that is an image carrier carrying an image in a predetermined color (yellow); and a charger 2Y, an optical writing unit 3Y, a developing device 4Y, a cleaning device 5Y, and a primary transfer roller 7Y that are disposed around the photosensitive drum 1Y.

The photosensitive drum 1Y is rotatably supported by a shaft. The charger 2Y is designed for electrically charging the photosensitive drum 1Y, and the surface of the photosensitive drum 1Y is electrically charged at a predetermined negative charge potential by the charger 2Y. The optical writing unit 3Y performs scan exposure, so that a latent image is formed on the photosensitive drum 1Y.

The developing device 4Y includes a developing roller to which a developing bias voltage that is negative relative to the ground is applied, and the surface potential of the developing roller (this surface potential will be hereinafter referred to as the “development potential”) is a predetermined negative voltage. The developing device 4Y further performs development with toner, to visualize the latent image on the photosensitive drum 1Y. As a result, an image (a toner image) corresponding to yellow is formed on the photosensitive drum 1Y.

Facing the photosensitive drum 1Y, the primary transfer roller 7Y is disposed on the inner peripheral side of the intermediate transfer belt 6 that is a transfer medium. A primary transfer voltage is applied to the primary transfer roller 7Y, and an electric charge of the opposite polarity from that of the toner is applied to the back side of the intermediate transfer belt 6 (the side to be in contact with the primary transfer roller 7Y). As a result, the image formed on the photosensitive drum 1Y is sequentially transferred to a predetermined position on the intermediate transfer belt 6. The cleaning device 5Y removes the toner remaining on the photosensitive drum 1Y.

Likewise, the other image formers 10M, 10C, and 10K include: photosensitive drums 1M, 1C, and 1K; and chargers 2M, 2C, and 2K, optical writing units 3M, 3C, and 3K, developing devices 4M, 4C, and 4K, cleaning devices 5M, 5C, and 5K, and primary transfer rollers 7M, 7C, and 7K, which are disposed around the photosensitive drums 1M, 1C, and 1K.

A belt cleaning unit 8 cleans the surface of the intermediate transfer belt 6 from which the image has been transferred. The cleaned intermediate transfer belt 6 is used in the next image transfer. The belt cleaning unit 8 includes cleaning members such as a brush roller, a blade, and a metal roller.

A secondary transfer roller 9 transfers the image formed with the respective colors transferred onto the intermediate transfer belt 6, onto a paper sheet P being conveyed at a predetermined timing by a sheet conveyor 20. The secondary transfer roller 9 is disposed in pressure contact with the intermediate transfer belt 6 to form a nip (a secondary transfer nip), and transfers the image onto the paper sheet P.

The sheet conveyor 20 conveys paper sheets P along a conveyance path. Paper sheets P are stored in a sheet feed tray 21, and the paper sheets P stored in the sheet feed tray 21 are caught and sent into the conveyance path by a sheet feeder unit 22. In the conveyance path, a plurality of conveyors that convey paper sheets P is disposed on the upstream side of a transfer nip, Each conveyor is formed with a pair of rollers pressed against each other, and at least one of the rollers is rotationally driven through an electric motor that is a driver. Each conveyor nips a paper sheet P and rotates, to convey the paper sheet P. Note that each conveyor is not necessarily formed with a pair of rollers, but may be formed with a pair of any other rotary members, such as a combination of belts or a combination of a belt and a roller.

The fixing device 40 is a device that fixes an image transferred onto a paper sheet P. The fixing device 40 includes: a fixing roller 41 and a pressure roller 42 that are disposed in pressure contact with each other to form a nip (a fixing nip); and a fixing heater 43 that heats the fixing roller 41, for example. The fixing device 40 performs pressure fixing with the fixing roller 41 and the pressure roller 42, and heat fixing with the fixing heater 43, to fix an image transferred onto a paper sheet P.

The paper sheet P subjected to a fixing process performed by the fixing device 40 is ejected by sheet ejection rollers 28 onto a sheet catch tray 29 attached to an outer side surface of the housing. In a case where image formation is also performed on the back surface of a paper sheet P, the paper sheet P having an image formed on the front surface thereof is conveyed by a switching gate 30 to reversing rollers 31 located in a lower portion. After nipping the bottom edge of the conveyed paper sheet P, the reversing rollers 31 reverses the paper sheet P by performing reverse conveyance, and sends the paper sheet P into a refeeding conveyance path. The paper sheet P sent to the refeeding conveyance path is conveyed by a plurality of refeeding conveyors. Thus, the paper sheet P is returned to the transfer position.

The controller 50 functions to integrally control the image forming apparatus. The controller 50 may be a computer that is formed primarily with a CPU, a ROM, a RAM, and an I/O interface, such as a microcomputer. The controller 50 controls the image formers 10Y, 10M, 10C, and 10K, the fixing device 40, and the like, to control image formation.

In relation to this embodiment, the controller 50 performs image stabilization control on each of the image formers 10Y, 10M, 10C, and 10K. In this image stabilization control, a plurality of patch images (toner images) is formed on the intermediate transfer belt 6 by varying the levels of parameters for image formation, and the image density (the toner adhesion amount) of each formed patch image is detected. The correction values for the parameters are determined in accordance with the image densities of the respective patch images, and parameter correction is performed in accordance with the correction values.

The controller 50 receives a detection signal from a density sensor (a density detector) 51 that detects the image density of a patch image formed on the intermediate transfer belt 6. The density sensor 51 includes a light emitting element (not shown) that emits light, and a light receiving element (not shown) that receives reflected light of the light emitted from the light emitting element. When light is emitted from the light emitting element onto the intermediate transfer belt 6, the light receiving element detects the light reflected by a toner image on the intermediate transfer belt 6. The intensity of the reflected light detected by the light receiving element has the value corresponding to the image density of the toner image. The density sensor 51 outputs the detection signal corresponding to a detection voltage generated in the light receiving element, to the controller 50.

Next, the concepts of reverse transfer and image stabilization control according to this embodiment are described prior to explanation of the image stabilization control to be performed by the controller 50.

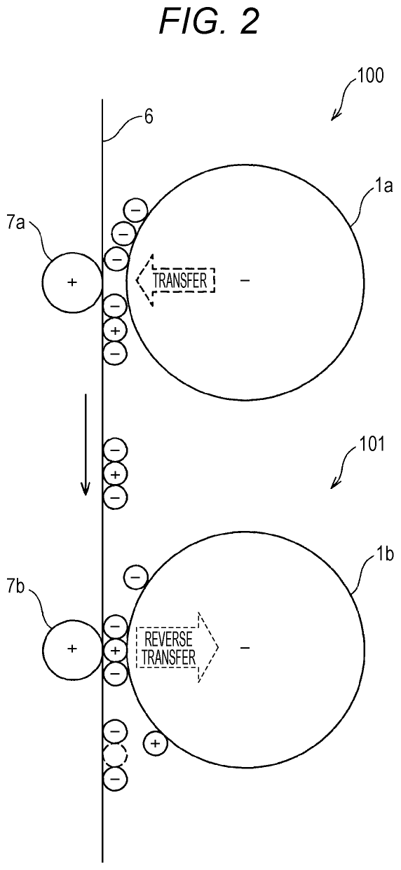

FIG. 2 is a diagram for explaining reverse transfer. FIG. 2 shows an image former 100 on the upstream side, and an image former 101 on the downstream side. Here, the image former 100 on the upstream side and the image former 101 on the downstream side conceptually represent an image former on the upstream side and an image former on the downstream side among the four image formers 10Y, 10M, 10C, and 10K. For example, if the yellow image former 10Y is the image former 100 on the upstream side, the magenta, cyan, and black image formers 10M, 10C, and 10K correspond to the image former 101 on the downstream side. Likewise, if the magenta image former 10M is the image former 100 on the upstream side, the cyan and black image formers 10C and 10K correspond to the image former 101 on the downstream side. Further, if the cyan image former 10C is the image former 100 on the upstream side, the black image former 10K corresponds to the image former 101 on the downstream side.

Reverse transfer is a phenomenon in which, when a toner image transferred onto the intermediate transfer belt 6 by the image former 100 on the upstream side passes through the transfer position of the image former 101 on the downstream side, the toner image does not stay on the intermediate transfer belt 6 but adheres to the photosensitive drum 1b of the image former 101 on the downstream side.

Specifically, at the transfer position of the image former 100 on the upstream side, which is in front of and behind the primary transfer nip between the primary transfer roller 7a and the intermediate transfer belt 6, electric discharge occurs due to the potential difference between the primary transfer roller 7a and the photosensitive drum 1a. With this electric discharge, the toner on the intermediate transfer belt 6 is weakly charged or oppositely charged. Accordingly, when the toner image on the intermediate transfer belt 6 reaches the transfer position of the image former 101 on the downstream side, the toner image repels the intermediate transfer belt 6, is attracted toward the photosensitive drum 1b, and is transferred onto the photosensitive drum 1b (reverse transfer).

The amount of reverse transfer of the toner image varies as described below in accordance with various parameters, or specifically, the transfer voltage (primary transfer voltage), the toner charge amount, the charge potential of the photosensitive drum 1a, and the like.

As the transfer voltage becomes higher, the potential difference between the primary transfer roller 7a and the photosensitive drum 1a becomes larger, and the discharge amount increases. Therefore, the amount of weakly charged toner tends to increase, and the amount of reverse transfer also tends to increase. Further, as the toner charge amount decreases, the amount of weakly charged toner increases When subjected to electric discharge, and accordingly, the amount of reverse transfer tends to increase. Further, as the charge potential of the photosensitive drum 1a becomes higher, the potential difference between the primary transfer roller 7a and the photosensitive drum 1a becomes larger, and the discharge amount also becomes larger. Therefore, the amount of weakly charged toner tends to increase, and the amount of reverse transfer also tends to increase. Further, as the pressure of the primary transfer roller 7b becomes higher, the physical contact force becomes greater. Therefore, reverse transfer becomes easier, and the amount of reverse transfer tends to increase. The amount of reverse transfer is also affected by the pressure and positional relationship between the primary transfer roller 7a and the intermediate transfer belt 6. Since the discharge amount changes with the spatial distances in front of and behind the primary transfer nip, the amount of weakly charged toner changes, and the amount of reverse transfer also changes.

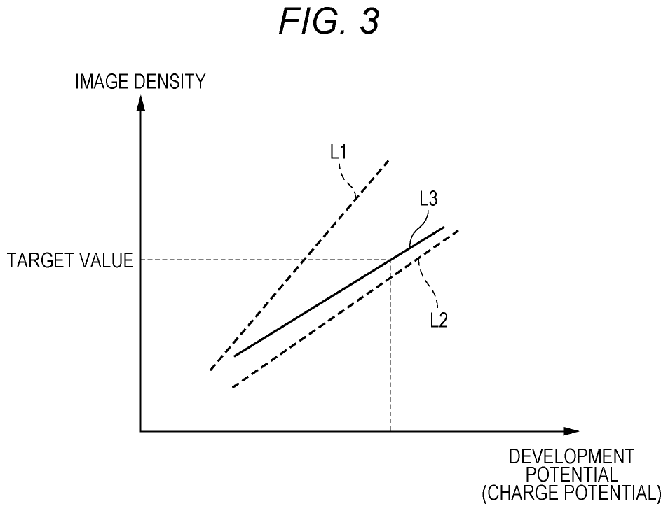

Next, an outline of image stabilization control is described. FIG. 3 is an explanatory chart showing an outline of image stabilization control. Since the development characteristics change due to various factors such as the toner charge amount, it is necessary to correct the development characteristics at an appropriate timing in daily use (image stabilization control). Specifically, a patch image for correction is formed on the intermediate transfer belt 6, the image density of the patch image is detected, and the development potential (an example of an image formation parameter) is corrected to be an optimum potential in accordance with the result of the detection. In this case, a plurality of patch images is formed by changing the level of the development potential, to save time and maintain accuracy. A linear approximation of the development potentials and the toner densities of the patch images at the times of the formation of the patch images is created, and a correction value (an optimum value) for the development potential is set according to the linear approximation, which represents the development characteristics. The image stabilization control is performed on each of the four image formers 10Y, 10M, 10C, and 10K.

Meanwhile, in the image stabilization control, the charge potential (an example of an image formation parameter) as well as the development potential is changed at the same level, so that fogging and carrier adhesion will not be caused in the developing device (not shown in FIG. 2). Because of the changes in the charge potential, the amount of reverse transfer at the primary transfer roller 7b in the image former 101 on the downstream side changes. In a case where the charge potential in the image former 101 on the downstream side has a constant value, the development characteristics of the image former 100 on the upstream side tend to be as indicated by dashed lines L1 and L2 in FIG. 3. Here, a dashed line L1 indicates the development characteristics in a case where the amount of reverse transfer is small, and a dashed line L2 indicates the development characteristics in a case where the amount of reverse transfer is large.

However, in a case where patch images are successively formed by the respective image formers 100 and 101, the charge potential also changes in the image former 101 on the downstream side. Therefore, the development characteristics of the image former 100 on the upstream side tend to be as indicated by a solid line L3 in FIG. 3, and correct development characteristics cannot be obtained. The development characteristics further change with changes in the charge potential in the image former 101 on the downstream side. Therefore, even if the correction value for the development potential is determined for the image former 101 on the upstream side, the optimum value (correction value) for the development potential in the image former 100 on the upstream side changes when the charge potential in the image former 101 on the downstream side is corrected. As a result, correction accuracy becomes lower.

To counter that in this embodiment, image stabilization control is performed on image formers ranging from the image former 101 on the downstream side to the image former 100 on the upstream side. In this case, a patch image formed in the image former 100 on the upstream to correct the image former 100 on the upstream side is made to pass through the transfer position of the image former 101 on the downstream side after the development potential and the charge potential are corrected in the image former 101 on the downstream side.

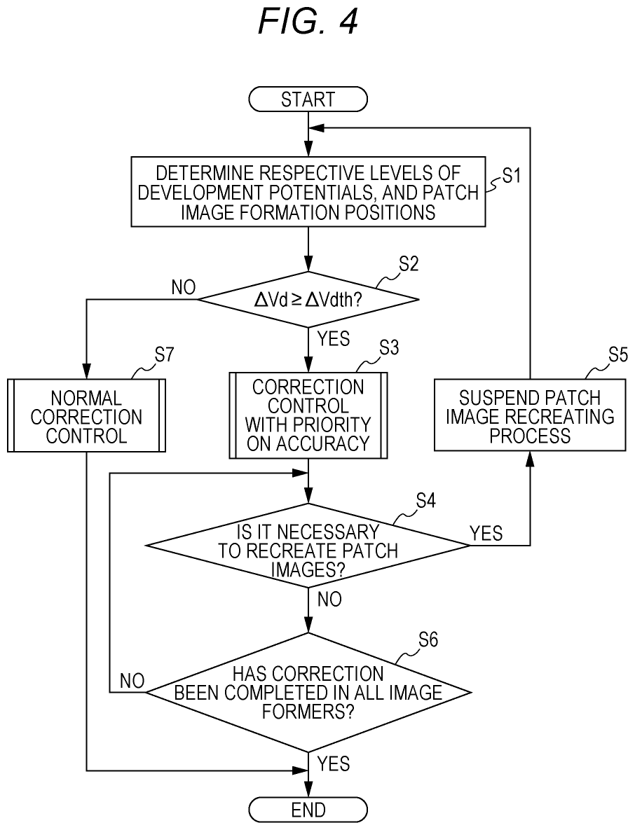

In the description below, a method of controlling the image forming apparatus according to this embodiment is explained. FIG. 4 is a flowchart showing the flow in a process to be performed by the image forming apparatus.

In image stabilization control, a plurality of patch images is formed by changing the levels of the development potential and the charge potential (hereinafter referred to as “development potential and the like”). In view of this, in step S1, the controller 50 determines the development potential and the like at different levels for forming a plurality of patch images, on the basis of the development characteristics and correction values for the development potential and the like calculated in the previous correction. In step S1, the controller 50 also calculates the patch image formation positions corresponding to the development potential and the like at the respective levels. The development potential and the like at the respective levels and the patch image formation positions are calculated for each of the four image formers 10Y, 10M, 10C, and 10K.

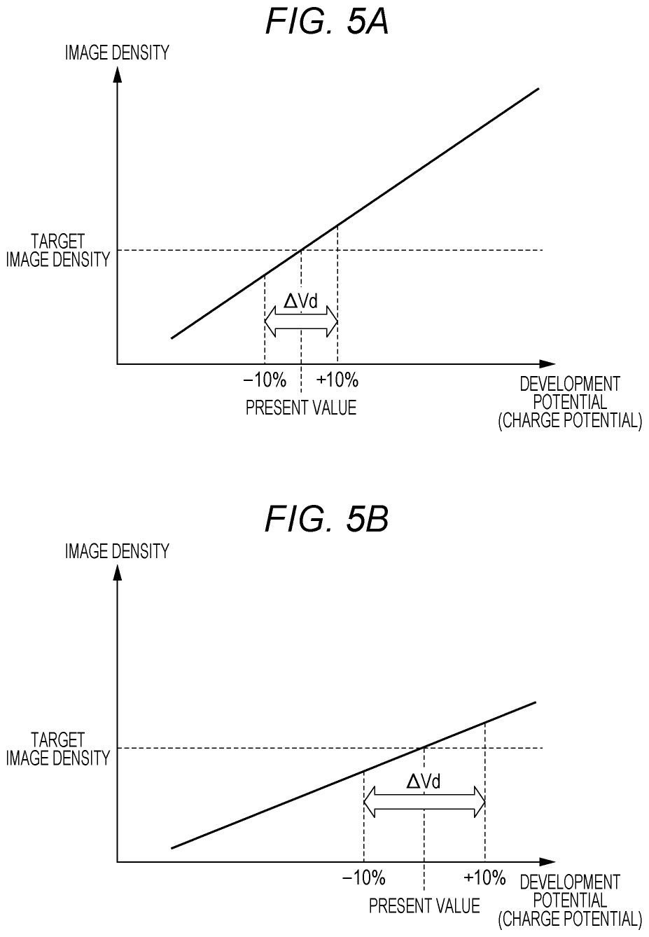

FIGS. 5A and 5B are explanatory charts showing the development potential and the like at different levels. FIG. 5A is an explanatory chart showing the development potential and the like at different levels on the assumption of first development characteristics. FIG. 5B is an explanatory chart showing the development potential and the like at different levels on the assumption of second development characteristics. For example, in a case where three levels of development potential and the like are determined, the present value (which is the previous correction value) and its ±10% values are employed. The amount of change ΔVd at the time of changing the development potential and the like in accordance with the three levels varies depending on the development characteristics.

In step S2, the controller 50 determines whether the amount of change ΔVd in the development potential and the like is equal to or larger than a preset threshold ΔVdth. The threshold ΔVdth is determined on the basis of the amount of change ΔVd in the development potential and the like at which the influence of reverse transfer is determined to be small even in a case where the development potential is changed in accordance with the three levels.

If the determination result is affirmative in step S2, or if the amount of change ΔVd in the development potential and the like is equal to or larger than the threshold ΔVdth, the process moves on to step S3. If the determination result is negative in step S2, or if the amount of change ΔVd in the development potential and the like is smaller than the threshold ΔVdth, on the other hand, the process moves oil to step S7.

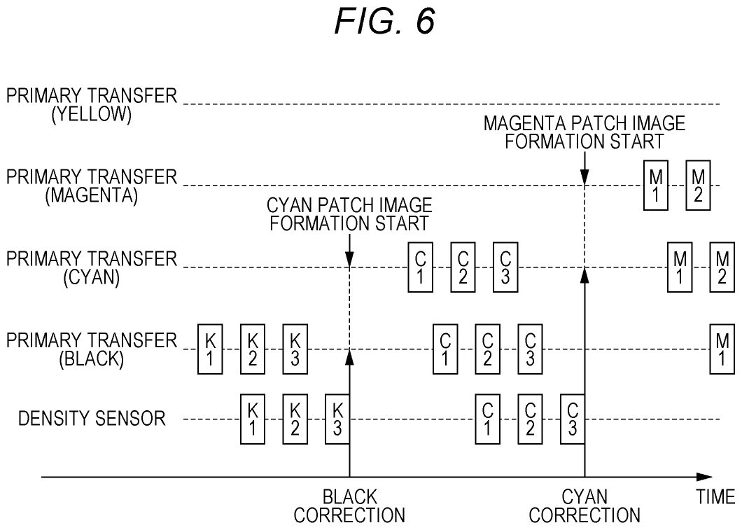

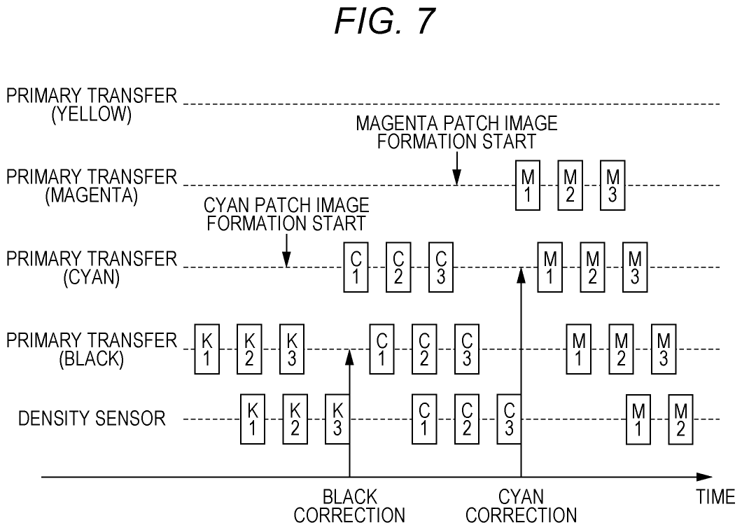

In step S3, the controller 50 performs correction control with priority on accuracy. The correction control with priority on accuracy is performed in parallel with the process shown in this flowchart. FIGS. 6 and 7 are explanatory charts showing the concept of correction control with priority on accuracy. In the correction control with priority on accuracy, the controller 50 first performs a process of creating patch images, starting from the black image former 10K located on the most downstream side.

On the basis of the development potential and the like at the respective levels and the patch image formation positions calculated in step S1, the controller 50 controls the black image former 10K, to sequentially form three patch images having different levels of development potential and the like. The three patch images are transferred onto the intermediate transfer belt 6. FIG. 8 is an explanatory chart showing the transition of the development potential and the like when the three patch images are formed.

Using the density sensor 51, the controller 50 detects the image densities of the three patch images formed by the black image former 10K. The three patch images transferred from the black image former 10K sequentially reach the density sensor 51 as the intermediate transfer belt 6 moves, and the density sensor 51 detects the image densities of the respective patch images.

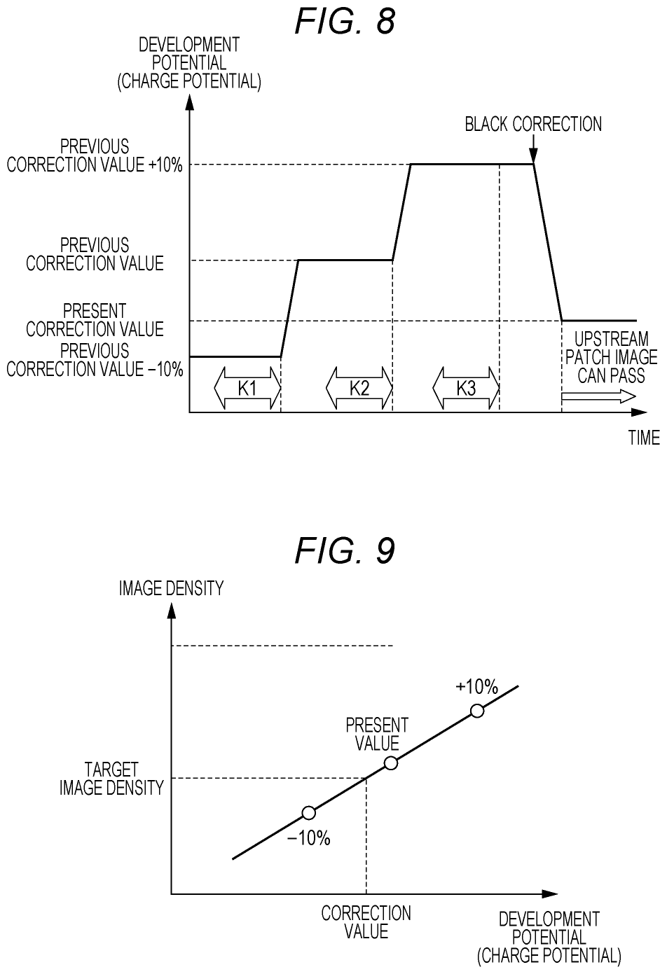

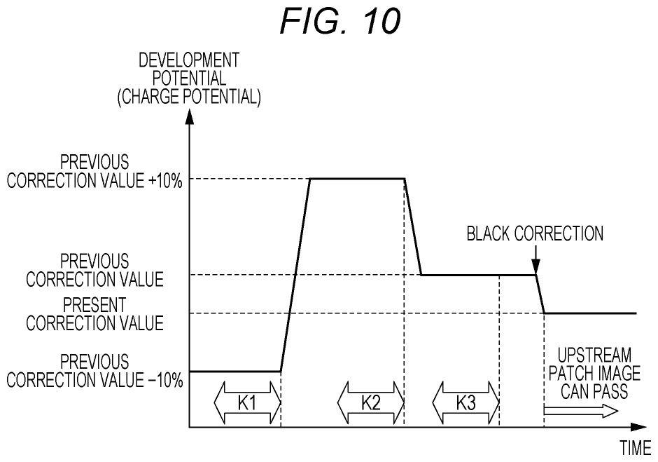

FIG. 9 is an explanatory chart showing the relationship between the development potential and the like and the image densities of the patch images. On the basis of detection results, the controller 50 creates a linear approximation of the development potential and the like and the image densities of the patch images. This linear approximation corresponds to the present development characteristics. The controller 50 then obtains the development potential and the like corresponding to the target image density from the development characteristics, and determines the development potential and the like to be the present correction value. The controller 50 then corrects the development potential and the like of the black image former 10K, on the basis of the correction value for the development potential and the like.

After the patch image creating process in the black image former 10K, the controller 50 starts a patch image creating process in the cyan image former 10C located on the upstream side of the black image former 10K. At this stage, the controller 50 causes the patch images formed by the cyan image former 10C to pass through the black image former 10K after the development potential and the like are corrected in the black image former 10K.

One of the methods for causing the patch images formed in the cyan image former 10C to pass through the black image former 10K in good time is starting patch image formation in the cyan image former 10C after correction of the development potential and the like in the black image former 10K in FIG. 6. On the other hand, to shorten the control time, patch image formation may be started in the cyan image former 10C before correction of the development potential and the like in the black image former 10K, as shown in FIG. 7.

The controller 50 also detects the image densities of the three patch images transferred from the cyan image former 10C. As a result, the correction value for the development potential and the like is determined, and the development potential and the like of the cyan image former 10C is corrected. Such a series of processes is also performed sequentially on the image formers 10Y and 10M on the upstream side. When the development potential and the like is corrected in the yellow image former 10Y located on the most upstream side, the correction control with priority on accuracy comes to an end.

In the above description, patch image formation is started from the lowest level, and patch images are sequentially formed while the level is raised. However, as shown in FIG. 10, the controller 50 may form the last patch image among the three patch images at the development potential and the like at the level estimated to be the closest to the development potential and the like determined to be the correction value. In this case, the development potential and the like at the level closest to the development potential and the like determined to be the previous correction value can be selected as the charge potential at the level estimated to be the closest.

In step S4, the controller 50 determines whether it is necessary to re-create patch images. As described above, the correction control with priority on accuracy is performed as a parallel process. However, in a case where the controller 50 determines that the calculated correction value for the development potential and the like is unsuitable in light of a certain reference, the controller 50 determines that patch images need to be re-created. In a case where the controller 50 determines that patch images need to be re-created, the controller 50 resumes the patch image creating process, starting from the black image former 10K located on the most downstream side. If it is determined that patch images need to be re-created, the determination result in step S4 is affirmative, and the process moves on to step S5. If it is not determined that patch images need to be re-created, on the other hand, the determination result in step S4 is negative, and the process moves on to step S6.

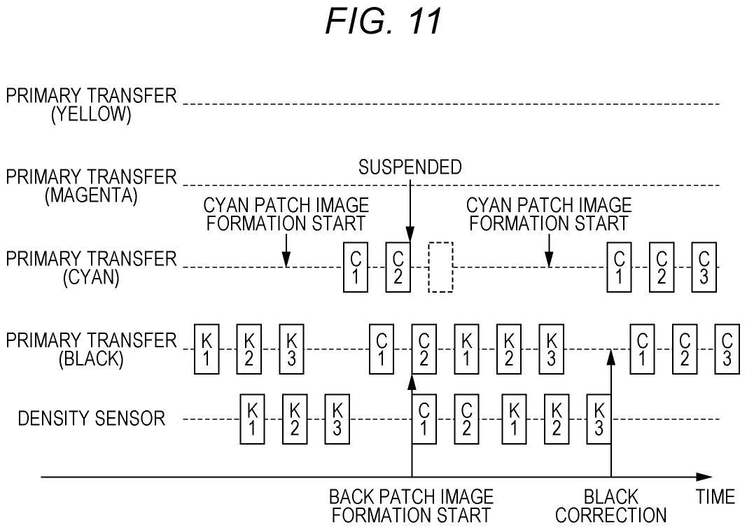

In step S5, the controller 50 suspends the patch image creating process. The process then returns to step S1, and the controller 50 calculates the development potential and the like at a plurality of levels, and patch image formation positions. As shown in FIG. 7, in a case where patch images are formed in an image former on the upstream side before correction in an image former on the downstream side, the controller 50 suspends the patch image creating process in the image former on the upstream side at the time when patch image re-creation is determined. The controller 50 then performs a patch image creating process, starting again from the image former on the downstream side. In this case, the controller 50 conducts patch image formation in the image former on the downstream side, so as to continue from the patch images formed. in the image former on the upstream side before the suspension. FIG. 11 is an explanatory chart showing a situation in which patch image re-creation is performed starting from the black linage former 10K in a case where patch image creation is suspended in the cyan image former 10C.

In step S6, the controller 50 determines whether correction has been completed in all the image formers 10Y, 10M, 10C, and 10K. If the correction has been completed, the determination result in step S6 is affirmative, and this process flow comes to an end. If the correction has not been completed, the determination result in step S6 is negative, and the process returns to step S4.

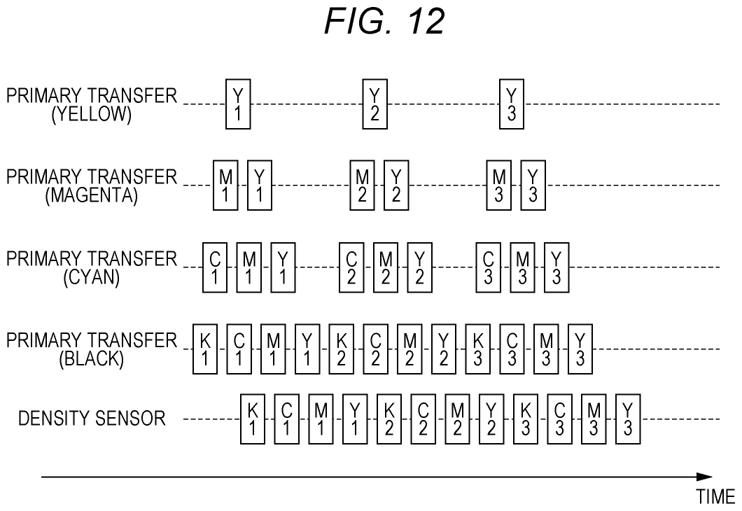

In step S7, the controller 50 performs normal correction control. FIG. 12 is an explanatory chart showing an outline of normal correction control. In normal correction control, for example, a set of patch images in the four colors are formed. After that, the development potential is switched to a different level, and a new set of patch images in the four colors are formed. This process is repeated. The controller 50 then sequentially detects the image densities of the patch images in the respective colors with the density sensor 51. On the basis of the results of the detection, the controller 50 determines the correction value for the development potential and the like of each of the image formers 10Y, 10M, 10C, and 10K, and performs correction. As a result, the time required for patch formation can be shortened, and downtime can be reduced.

As described above, in this embodiment, the controller 50 performs image stabilization control on image formers ranging from the image former 101 on the downstream side to the image former 100 on the upstream side. At this stage, the controller 50 causes the patch images formed in the image former 100 on the upstream side to pass through the image former 101 on the downstream side after parameter correction is performed in the image former 101 on the downstream side.

With this configuration prior to the parameter correction in the image former 100 on the upstream side, the parameters for the image former 101 on the downstream side are corrected. In addition to that, after the parameters for the image former 101 on the downstream side are corrected, the patch images formed by the image former 100 on the upstream side pass through the image former 101 on the downstream side. Accordingly, the patch images formed by the image former 100 on the upstream side can be evaluated, with the parameters for the image former 101 on the downstream side leaving been corrected. Thus, the influence of the correction in the image former 101 on the downstream side is taken into account in correcting the parameters for the image former 100 on the upstream side. Because of this, it is also possible to appropriately correct the parameters for the image former 100 on the upstream side, and thus, desired image formation characteristics can be achieved. As a result, appropriate image formation characteristics can be obtained from image formers ranging from the image former 100 on the upstream side to the image former 101 on the downstream side.

Further, in this embodiment, the controller 50 starts patch image formation in the image former 100 on the upstream side after performing parameter correction in the image former 101 on the downstream side.

With this configuration, even if patch images are re-created, the time required for correction can be shortened, and further, toner consumption can be reduced.

However, the controller 50 may start patch image formation in the image former 100 on the upstream side before performing parameter correction in the image former 101 on the downstream side.

With this configuration, it is possible to reduce the time required for correction in a case where patch image re-creation is not performed.

Further, in this embodiment, in a case where the controller 50 suspends the patch image formation in the image former 100 on the upstream side, and conducts patch image re-creation starting from the image former 101 on the downstream side, the controller 50 conducts patch image formation in the image former 101 on the downstream side, to continue from the patch images formed in the image former 100 on the upstream side before the suspension.

With this configuration, the patch images formed in re-creation by the image former 101 on the downstream side are arranged immediately after the patch images formed before suspension. As a result, the interval between patch images can be narrowed, and thus, the time required for correction can be shortened.

Further, in this embodiment, the parameters include development potential and charge potential.

With this configuration, appropriate development characteristics can be obtained from image formers ranging from the image former 100 on the upstream side to the image former 101 on the downstream side.

In this embodiment, the controller 50 changes the development potential and the like. In this case, the controller 50 may also change the transfer voltage with the development potential and the like. The transfer voltage is preferably changed not only at the time of patch image formation but also at the time of correction depending on the correction value.

In this configuration, as the development potential and the like is changed, the electrostatic force to be applied to the toner at the primary transfer nip changes, and therefore, the optimum value of the transfer voltage changes. Accordingly, when the development potential and the like are changed at each level, or after the correction value is determined, the transfer voltage is also optimized so that further improvement in accuracy can be expected.

Further, in this embodiment, the controller 50 may form the last patch image among patch images formed at varied levels of development potential and the like, using the development potential and the like at the level estimated to be the closest to the development potential and the like determined to be the correction value.

Specifically, the development potential and the like at the level estimated to be the closest are at the level closest to the development potential and the like determined to be the previous correction value.

With this configuration, the development potential and the like at the time of formation of the last patch image are set at a value close to the determined correction value, so that the amount of change in the development potential and the like can be reduced. Thus, the time required for correction can be shortened.

Development characteristics also change with environments such as humidity and temperature. Therefore, in determining the level of the patch image to be formed last, the environments in which the device is placed may be taken into consideration.

Further, in this embodiment, the controller 50 calculates the amount of change when changing the level of a parameter affecting the amount of reverse transfer, and switches the operation mode of the image stabilization control in accordance with the amount of change.

With this configuration, it is possible to switch between normal correction control and correction control according to this embodiment (correction control with priority on accuracy). Accordingly, normal correction control can be selected in a situation where the influence of reverse transfer is small, and appropriate development characteristics can be expected at the time of correction. Thus, it is possible to prevent an increase in unnecessary control time.

Here, the parameter that affects the amount of reverse transfer is the charge potential as described in the above embodiment, but may be some other parameter as described with reference to FIG. 2.

Although an image forming apparatus according to this embodiment has been described so far, the present invention is not limited to the above described embodiments, and various modifications may of course be made to the embodiment within the scope of the invention. The present invention extends not only to the image forming apparatus but also to a control and a program for controlling the image forming apparatus.

Further, in this embodiment, the image forming apparatus is described as having a configuration in which an intermediate transfer belt is provided to perform primary transfer, but the present invention can also be applied to a method of transferring an image directly onto a paper sheet. In the case of a direct transfer system, a paper sheet or a transfer belt is the transfer medium.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that has a plurality of image formers arranged from an upstream side toward a downstream side in a moving direction of a transfer medium, each of the image formers forming a toner image on the transfer medium, the image forming apparatus comprising:
a density detector that detects densities of toner images formed by the plurality of image formers; and
a hardware processor that performs image stabilization control on each of the image thinners, the image stabilization control being performed to form a plurality of patch images by changing levels of a parameter for image formation, the image stabilization control being performed to conduct correction on the parameter in accordance with respective densities of the patch images detected by the density detector,
wherein the hardware processor performs the image stabilization control on the image formers from a downstream-side image former to an upstream-side image former, and the patch images formed in the upstream-side image former are made to pass through the downstream-side image former after correction of the parameter is performed in the downstream-side image former.

2. The image forming apparatus according to claim 1,
wherein the hardware processor starts formation of the patch images in the upstream-side image former, after conducting correction of the parameter in the downstream-side image former.

3. The image forming apparatus according to claim 1,
wherein the hardware processor starts formation of the patch images in the upstream-side image former, before conducting correction of the parameter in the downstream-side image former.

4. The image forming apparatus according to claim 3,
wherein, when suspending the formation of the patch images in the upstream-side image former and conducting re-creation of the patch images starting from the downstream-side image former, the hardware processor performs formation of the patch images in the downstream-side image former to continue from the patch images formed in the upstream-side image former before the suspension.

5. The image forming apparatus according to claim 1,
wherein each of the image formers includes:
an image carrier that is rotatably supported by a shaft and carries a toner image;
a charger that electrically charges a surface of the image carrier; and
a developing device that develops the image carrier with toner, and
the parameter includes:
a development potential of the developing device; and
a charge potential of the image carrier.

6. The image forming apparatus according to claim 5,
wherein each of the image formers further includes a transferrer that transfers the toner image being carried by the image carrier onto the transfer medium, and
the hardware processor changes a transfer voltage in accordance with change in the development potential and the charge potential.

7. The image forming apparatus according to claim 5,
wherein the hardware processor forms the patch image to be formed last among the plurality of patch images formed at varied levels of the development potential and the charge potential, using a development potential and a charge potential at a level estimated to be the closest to a development potential and a charge potential determined to be a correction value.

8. The image forming apparatus according to claim 7,
wherein the development potential and the charge potential at the level estimated to be the closest are a development potential and a charge potential at a level closest to a development potential and a charge potential determined to be a previous correction value.

9. The image forming apparatus according to claim 1,
wherein the hardware processor calculates an amount of change when changing the level of the parameter affecting an amount of reverse transfer, and switches an operation mode of the image stabilization control in accordance with the amount of change.

10. A method of controlling an image forming apparatus that has a plurality of image formers arranged from an upstream side toward a downstream side in a moving direction of a transfer medium, each of the image formers forming a toner image on the transfer medium, the method comprising
performing image stabilization control on each of the image formers, the image stabilization control being performed to form a plurality of patch images by changing levels of a parameter for image formation, the image stabilization control being performed to conduct correction on the parameter in accordance with respective densities of the patch images detected by the density detector,
wherein the image stabilization control is performed on the image formers from a downstream-side image former to an upstream-side image former, and the patch images formed in the upstream-side image former are made to pass through the downstream-side image former after correction of the parameter is performed in the downstream-side image former.

11. A non-transitory recording medium storing a computer readable program to be executed by a computer of an image forming apparatus that has a plurality of image formers arranged from an upstream side toward a downstream side in a moving direction of a transfer medium, each of the image formers forming a toner image on the transfer medium,
the program causing the computer to function as
a hardware processor that performs image stabilization control on each of the image formers, the image stabilization control being performed to form a plurality of patch images by changing levels of a parameter for image formation, the image stabilization control being performed to conduct correction on the parameter in accordance with respective densities of the patch images detected by the density detector,
wherein the hardware processor performs the image stabilization control on the image formers from a downstream-side image former to an upstream-side image former, and the patch images formed in the upstream-side image former are made to pass through the downstream-side image former after correction of the parameter is performed in the downstream-side image former.
